(19) United States
(12) Patent Application Publication
(10) Pub. No.: US 2016/0245001 A1
(43) Pub. Date: Aug. 25, 2016

(54) AUTOMATIC LOCKING ASSEMBLY

(71) Applicant: Yat Chung KAN, Hong Kong (HK)

(72) Inventor: Yat Chung KAN, Hong Kong (HK)

(21) Appl. No.: 14/631,174

(22) Filed: Feb. 25, 2015

(51) Int. Cl. E05C 3/12

(52) U.S. Cl. CPC E05C 3/12

(57) ABSTRACT

According to embodiments of the present invention, devices and methods are provided for automatically locking windows or doors when the windows and doors make contact with their respective frames. In one embodiment, a lock assembly is provided having a tongue housing, a tongue member, an actuator, a vertical housing, and/or a vertical protruding part. In embodiments, the lock assembly makes contact with a plate attached to a door or window frame when a door or window is closed. This causes the vertical protruding part to extend to the bottom end of the vertical housing to engage a lock receiving device attached to the door or window frame.

### FIELD OF THE INVENTION

This invention generally relates to locking mechanisms of doors and windows. Specifically, this invention relates to automatically securing doors and windows once they are ajar or not in a predetermined open position.

### BACKGROUND OF THE INVENTION

Home security is more important than ever; not just to protect property but also to protect children, elderly, and family members in general. To prevent thefts and burglaries, conventional homes and the like are generally equipped with individual locks or latches for each of the doors and windows that need to be locked independently before leaving the house unattended. Oftentimes, one or more doors or windows are neglected and remain vulnerable as an entry point of a burglar. Although the locking of doors and windows would not likely discourage a professional burglar, the great majority of burglars are merely amateurs who would usually be dissuaded from breaking into a house which had all of its doors and windows in a locked position.

Therefore, there is a need in the art to put in place a locking mechanism that makes family members feel safe and secure at home. It is an object of the present invention to provide a controlled locking mechanism that is simple and cost effective to prevent movement of the locking elements when any of the doors or windows is ajar or in any position other than a predetermined open position.

### SUMMARY OF THE INVENTION

The present invention aims at the elimination of the above-mentioned problems, and has as its object the provision of a lock assembly for automatically locking windows or doors when the windows and doors make contact with frames of the windows or doors. According to embodiments of the present invention, a lock assembly includes a tongue housing, a tongue member, an actuator pivotally coupled to the housing, a housing disposed on the tongue housing, and a vertical protruding part disposed within the housing.

In one embodiment, the tongue housing includes a front surface, a back side, a bottom side, and a top surface, wherein a passage is defined between the front surface and the back side. The front surface has an opening. The tongue housing, in an embodiment, is adapted so that a tongue member can slide along the passage anywhere between the front surface and the back side, wherein a tip portion of the tongue member is configured to protrude through the opening when the tongue member reaches the front surface. Further, the embodied locking mechanism provides an actuator pivotally coupled to the back side of the tongue housing. The actuator is configured to rotate when the tongue member reaches the back side of the tongue housing. Even further, a vertical housing, disposed on the bottom side of the tongue housing, is included. The vertical housing includes a top end and a bottom end. Within the vertical housing there is a vertically protruding part. The vertical protruding part is configured to slide from the top end to the bottom end.

In one embodiment, the lock assembly is in an ajar or a position other than a predetermined open position. In which case, the vertical protruding part of the embodied locking mechanism reaches to the bottom end of the vertical housing to engage a lock receiving device attached to a door or window frame. When that happens, the lock assembly makes contact with a plate attached to a door or window frame when a door or window is closed. At this point, the tip of the tongue member makes contact with the plate attached to the door or window when the lock assembly makes contact. The tongue member is pushed back to slide along the passage of the tongue housing towards the direction of the back side as a result of the contact made between the tip of the tongue member and the plate attached to the door or window. Meanwhile, the sliding tongue member engages the actuator causing the actuator to rotate. The rotating actuator then makes contact with vertical protruding part, causing the vertical protruding part be pushed down as a result of the contact made with the rotating actuator. The contact then engages the vertical protruding part, forcing the element to extend towards the bottom end of the vertical housing thereby engaging the lock receiving device attached to a door or window frame.

In another embodiment, the lock assembly is in contact with the door or window. When a home user opens the door or window, the tongue member loses contact with the plate attached to the door or window frame. In this embodiment, the tongue member is pushed back to slide along the passage of the tongue housing in the direction of the front side as a result of the separation between the tip of the tongue member and the plate attached to the door or window. The sliding tongue member then disengages the actuator causing the actuator to rotate to its previous position. As a result, the rotating actuator, in this embodiment, loses contact with the vertical protruding part, causing the vertical protruding part to be retracted upward as a result of losing contact with the rotating actuator. The retracting motion forces the vertical protruding part to move away from the bottom end of the vertical housing thereby disengaging the lock receiving device attached to the door or window frame.

The object of the present invention is to overcome the disadvantages and drawbacks of the prior art and to provide an internal lock for convention or even sliding doors or windows. The present invention overcomes these drawbacks by featuring the characteristics of the abovementioned type of external lock (i.e. with the configuration of using tongue members, tongue housing, and pivoting actuators that causes motions to protruding parts to engage lock receiving devices).

### BRIEF DESCRIPTION OF THE DRAWINGS

FIG. 1 illustrates a blown-apart perspective view of a tongue member and an actuator, in accordance with an embodiment of the present invention.

FIG. 2 shows a blown-apart perspective view of a tongue housing and a plate for attaching to a door or window frame, in accordance with an embodiment of the present invention.

FIG. 3 shows a blown-apart elevation view of a vertical protruding part, in accordance with an embodiment of the present invention.

FIG. 4 shows a blown-apart perspective view a vertical housing containing the vertical protruding part of FIG. 3, in accordance with an embodiment of the present invention.

FIG. 5 shows a blown-apart perspective overview of the locking mechanism in accordance with an embodiment of the present invention.

### DETAILED DESCRIPTION

With reference to the accompanying Figures, indicative, but not restricting embodiments of the invention will be described.

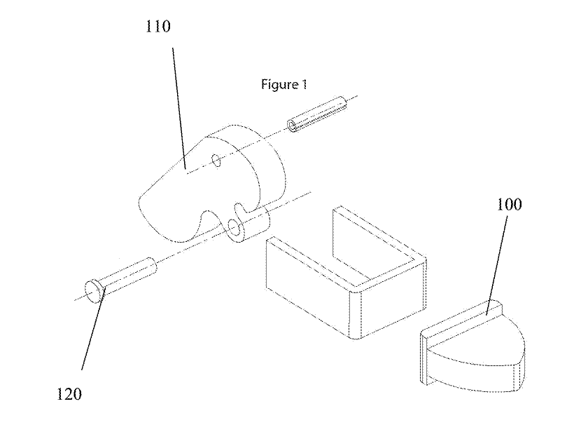

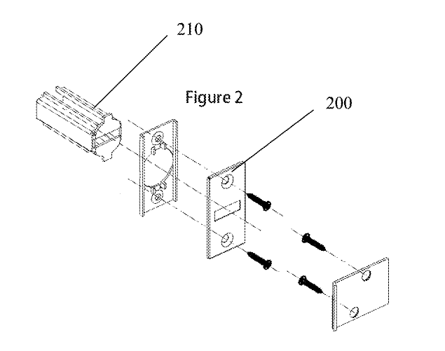

FIG. 1 illustrates a blown-apart perspective view of a tongue member and an actuator, in accordance with an embodiment of the present invention. FIG. 1 illustrates the tongue member 100 and the actuator 110 of the locking mechanism that can be used in a sliding door or window panel and, in particular of the vertically extending part thereof at the side where at the door or window panel opens or shuts, in accordance with an example implementing the present invention. The actuator 110 may be implemented as a cam or a rotating arm pivoting at a point connecting to the axel pin 120. Each of the ends of the actuator 110 may have a curved surface that may be pivotally coupled to the back side of the tongue housing 210 shown in FIG. 2.

FIG. 2 shows a blown-apart perspective view of a tongue housing and a plate for attaching to a door or window frame, in accordance with an embodiment of the present invention. The actuator 110 is configured to rotate when the tongue member 100 is extended to the back side of the tongue housing 210. Referring now to FIG. 2, the tongue member 100 can slide along the passage anywhere between the front surface and the back side of the tongue housing 210. In this example, the tongue housing 210 is cylindrical in shape, but it may be implemented with different forms, styles, and/or shapes; including, but not limited to, rectangular or even a square shape. Alternatively, it may also be implemented as a chamber.

The tongue housing 210 can be longitudinal in nature, with a primary objective to house the tongue member 100 moving from one end to another. Tongue housing 210 includes a front surface, a back side, a bottom side, and/or a top surface. A passage is defined between the front surface and the back side. Also, the front surface contains an opening or a slot, so that a tip portion of the tongue member 100 is configured to protrude through the opening or slot when the tongue member 100 reaches the front surface. When a door or window is closed, the plate 200 attached to a door or window frame makes contact with the tip portion of the tongue member, causing the plate 200 attached to a door or window frame to make contact with the tip portion of the tongue member.

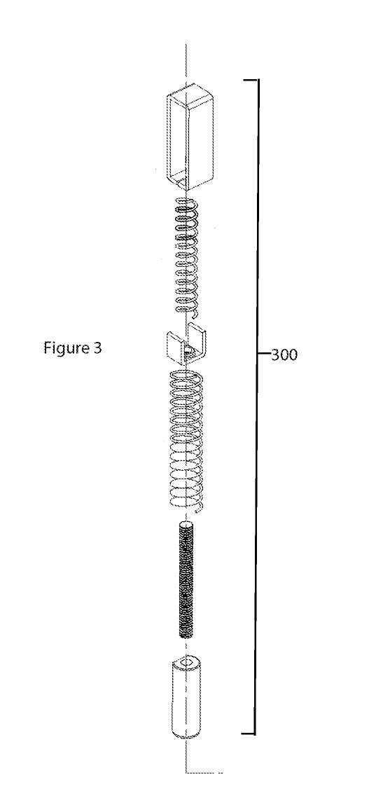

When the tip portion of the tongue member 100 makes contact with the plate 200, a reaction force is applied by the plate 200 to the tongue member 100 through the tip portion. The reaction force causes the tongue member 100 to slide along the passage of the tongue housing 210 towards the direction of the back side. The sliding tongue member 100, while sliding toward the back side of the tongue housing 210, eventually engages the actuator 110. This sliding force causes the actuator 110 to rotate counterclockwise, causing the rotating actuator 110 to make contact with the vertical protruding part 300, as shown in FIG. 3.

Referring now to FIG. 3, a blown-apart elevation view of a vertical protruding part is depicted in accordance with an embodiment of the present invention. The vertical protruding part 300 is implemented as an axial shaft but is not limited to longitudinal or cylindrical in shape.

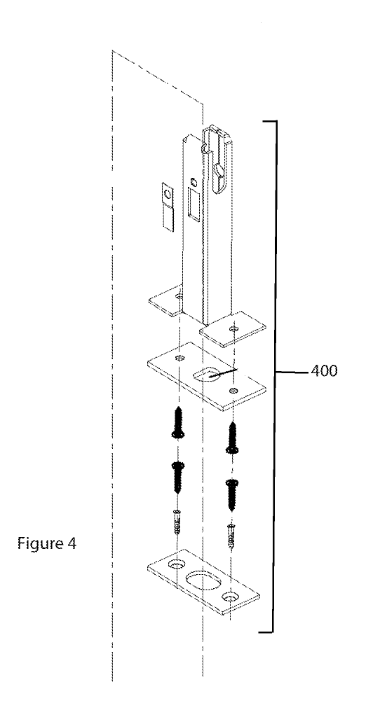

Proceeding to FIG. 4, a blown-apart perspective view is shown of a vertical housing containing the vertical protruding part of FIG. 3, in accordance with an embodiment of the present invention. In this Figure, the vertical protruding part 300 is depicted having coil springs, so that the vertical protruding part 300 may be pushed down to reach the bottom end of the vertical housing 400 to engage a lock receiving device that is attached to a door or window frame.

On the other hand, when the door or window is opened, the lock assembly is configured to lose contact with or separate from the plate 200 attached to the door or window frame. The procedure merely reverses the aforementioned sequence of operations. First, the tongue member 100 is pushed back to slide along the passage of the tongue housing 210 in the direction of the front side as a result of the separation of the tip of the tongue member 100 and the plate 200 attached to the door or window. At this point, the sliding tongue member 100 disengages the actuator 110 causing the actuator 110 to rotate to its previous position. As a result, the rotating actuator 110 becomes separated from the vertical protruding part 300. A retracting motion is then facilitated within the coil spring of the vertical protruding part 300, causing the vertical protruding part 300 to move away from the bottom end of the vertical housing 400 thereby disengaging the lock receiving device attached to the door or window frame.

The alternative locking mechanism, in the case of a door, is activated by the opening of the door. When the door is opened, it causes the plunger rod to be pushed out of a copper-based housing by a compression spring. The plunger then extends across the opening of the copper-based which is also housing a bolt, thereby preventing the bolt from being pushed out of copper-based housing. When the door is subsequently closed, it pushes the rod back into the copper-based housing. This causes the vertical edge of the door to restrain movement of the bolt until the copper-based housing within the door is aligned with the portion of the copper-based housing for receiving the door lock.

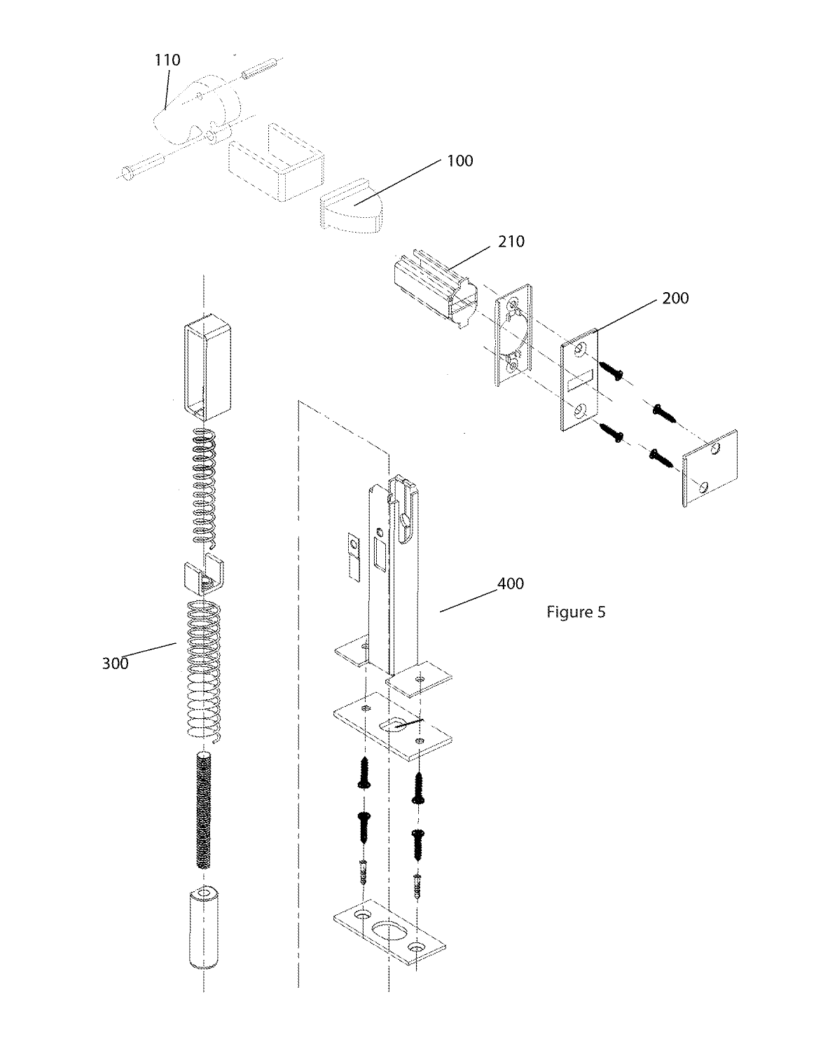

FIG. 5 shows a blown-apart perspective overview of the locking mechanism in accordance with an embodiment of the present invention. This Figure depicts the arrangement of all of the aforementioned parts with respect to one another to be installed on a door or window frame. The locking mechanism may be installed on any point in ingress or egress for humans, animals and/or goods.

In practice, the locking device may ideally be installed during the construction of the house to facilitate the installation of wires as well as locking elements. However, in view of the compact localized nature of the locking elements, the system can also be retro-fitted or installed with a minimum amount of damage to a house or door for which construction has been completed. It should also be noted that when a door or window is left ajar and the associated plungers are prevented from being extended. Thus, the associated limit switch is not closed and an associated signal light does not light up.

It is obvious from the foregoing that more than one master panel may be employed and the number of circuit elements expanded as required for a particular application. For example, panels may be installed at the back door, at the front door in the master bedroom. Moreover, the device may be provided with a standby power source such as a battery which would automatically power the system in the event of failure of the line voltage. Clearly, the system can be applied to locking elements other than bolts without departing from the spirit of the invention.

It is to be understood that the foregoing detailed description and accompanying drawings relate to a preferred illustrative embodiment of the invention. However, various changes and modifications may be made without departing from the spirit and scope of the invention. Accordingly, the present invention is not limited to the specific arrangements as shown in the drawings and described in detail herein above. The exemplary materials, constructions and illustrations included in the preferred embodiment and this patent application should therefore not be construed to limit the scope of the present invention, which is defined by the appended claims.

While the disclosed invention has been taught with specific reference to the above embodiments, a person having ordinary skill in the art will recognize that changes may be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

1. A lock assembly for automatically locking a window or door when the window or door makes contact with a frame of the window or door, comprising:
a tongue housing having a front surface, a back side, a bottom side, and a top surface, wherein a passage is defined between the front surface and the back side, the front surface having an opening;
a tongue member that slides along the passage anywhere between the front surface and the back side, wherein a tip portion of the tongue member is configured to protrude through the opening when the tongue member reaches the front surface;
an actuator pivotally coupled to the back side of the tongue housing, wherein the actuator is configured to rotate when the tongue member reaches to the back side of the tongue housing;
a vertical housing disposed on the bottom side of the tongue housing, wherein the vertical housing has a top end and a bottom end; and
a vertical protruding part disposed within the vertical housing, wherein the vertical protruding part is configured to slide from the top end to the bottom end.

2. The lock assembly of claim 1, wherein the vertical protruding part sliding to the bottom end of the vertical housing engages a lock receiving device attached to the door frame or window frame.

3. The lock assembly of claim 1, wherein the lock assembly makes contact with a plate attached to the door frame or the window frame when the door or the window is closed.

4. The lock assembly of claim 3, wherein the tip of the tongue member makes contact with the plate attached to the door or the window when the lock assembly makes contact with the window frame or the door frame.

5. The lock assembly of claim 4, wherein the tongue member is pushed back to slide along the passage of the tongue housing in the direction of the back side as a result of the contact made between the tip of the tongue member and the plate attached to the door or window.

6. The lock assembly of claim 5, wherein the sliding tongue member engages the actuator causing the actuator to rotate.

7. The lock assembly of claim 6, wherein the rotating actuator makes contact with vertical protruding part.

8. The lock assembly of claim 7, wherein the vertical protruding part is pushed down as a result of the contact made with the rotating actuator.

9. The lock assembly of claim 8, wherein the vertical protruding part is extendable to the bottom end of the vertical housing thereby engaging the lock receiving device attached to a door or window frame.

10. The lock assembly of claim 1, wherein the lock assembly loses contact with the plate attached to the door or window frame when the door or window is opened.

11. The lock assembly of claim 10, wherein the tongue member is pushed back to slide along the passage of the tongue housing in the direction of the front side after becoming separated from the tip of the tongue member and the plate attached to the door or window.

12. The lock assembly of claim 11, wherein the sliding tongue member disengages the actuator causing the actuator to rotate to an original position.

13. The lock assembly of claim 12, wherein the rotating actuator becomes separated from the vertical protruding part.

14. The lock assembly of claim 13, wherein the vertical protruding part is retracted upward as a result of being separated from the rotating actuator.

15. The lock assembly of claim 14, wherein the vertical protruding part moves away from the bottom end of the vertical housing thereby disengaging the lock receiving device attached to the door or window frame.
